(19) United States
(12) Patent Application Publication
(10) Pub. No.: US 2014/0365221 A1
(43) Pub. Date: Dec. 11, 2014

(54) METHOD AND APPARATUS FOR SPEECH RECOGNITION

(71) Applicant: NOVOSPEECH LTD., Petach Tikva (IL)

(72) Inventor: Yossef Ben-Ezra, Rehovot (IL)

(21) Appl. No.: 14/469,678

(22) Filed: Aug. 27, 2014

Related U.S. Application Data
(63) Continuation-in-part of application No. 14/237,128, filed on Feb. 4, 2014, now Pat. No. 8,849,667.
(60) Provisional application No. 61/677,605, filed on Jul. 31, 2012.

(51) Int. Cl. G10L 15/14

(52) U.S. Cl. CPC G10L 15/142
USPC 704/256.1

(57) ABSTRACT

A computer-implemented method performed by a computerized device, a computerized apparatus and a computer program product for recognizing speech, the method comprising: receiving a signal; extracting audio features from the signal; performing acoustic level processing on the audio features; receiving additional data; extracting additional features from the additional data; fusing the audio features and the additional features into a unified structure; receiving a Hidden Markov Model (HMM); and performing a quantum search over the features using the HMM and the unified structure.

### CROSS-REFERENCE TO RELATED APPLICATION

This application is a Continuation in Part and claims the benefit of U.S. patent application Ser. No. 14/237,128 filed Feb. 4, 2014, which is a National Phase Application of International Patent Application No. PCT/IL2013/050577, filed Jul. 7, 2013, claiming priority from U.S. Provisional Application No. 61/677,605 filed Jul. 31, 2012, all entitled “Method and Apparatus for Speech Recognition” and hereby incorporated by reference in their entirety.

### TECHNICAL FIELD

The present disclosure relates to speech recognition in general, and to a method and apparatus for using multimodal information and dynamic quantum search in speech recognition, in particular.

### BACKGROUND

Speech recognition (SR), also known as Automatic Speech Recognition (ASR), Speech to Text (S2T) or other names, belongs to a large family of audio analysis techniques, used for automatically identifying and extracting information from audio signals. Such techniques may include user recognition, user verification, user identification, emotion analysis, word spotting, and continuous speech recognition which refers to translating spoken words into text.

Some SR engines require specific user training in which an individual speaker reads aloud sections of text into an SR system in order to recognize the user's voice and obtain its characteristics for future recognition. However, such training is not always feasible and it is often required to transcribe voices of unknown or unrecognized speakers in which even the language or the accent may not be a-priori known. Such systems may be referred to as “speaker independent”.

A main obstacle in recognizing speech relates to the computation complexity involved in current methods, which is tightly related to the recognition quality. Recognizing spoken words at high quality, i.e., low error rate, requires significant computing resources or significant processing time. Therefore, in order to process large volume of audio and retrieve the spoken words, efficient methods are required. For example, if a call center having hundreds or thousands of agents simultaneously speaking with customers is required to transcribe a significant part of the captured or recorded calls, then in order to obtain meaningful results with reasonable resources, processing an audio signal should take no more than a very small fraction of the length of the signal.

One of the stages of common S2T methods relates to identifying the most probable phoneme sequence that may be obtained from the input audio signal. This stage is particularly time consuming and its complexity may have significant effect on the performance of the whole process.

### BRIEF SUMMARY

One exemplary embodiment of the disclosed subject matter is a computer implemented method performed by a computerized device, comprising: receiving a signal; extracting audio features from the signal; performing acoustic level processing on the audio features; receiving additional data; extracting additional features from the additional data; fusing the audio features and the additional features into a unified structure; receiving a Hidden Markov Model (HMM); and performing a quantum search over the features using the HMM and the unified structure. Within the method, the quantum search is optionally a dynamic quantum search. Within the method, the dynamic quantum search optionally comprises: for each time window performing; initializing scores for each predecessor word and time pointers; performing time alignment of the scores based on dynamic programming; propagating back the time pointers; and pruning branches representing irrelevant paths; and for each successor word performing: converting a search space into a quantum search space; and determining a most probable predecessor word and time boundaries thereof; storing the predecessor word or an indication thereof; and storing the time boundaries. Within the method, the additional data is optionally visual data of a speaker associated with the signal. Within the method, processing the additional data optionally comprises image processing. The method may further comprise: receiving an indication of a location associated with the signal; using the indication for adapting a model in accordance with the location; and using the model in the quantum search. Within the method, the model is optionally an acoustic model or a language model. The method may further comprise a training step for creating the HMM, the training step optionally comprising: receiving a training signal; extracting training audio features from the training signal; performing acoustic level processing on the training audio features; receiving additional training data; extracting additional training features from the additional training data; fusing the training audio features and the additional training features into a unified structure; and creating the HMM based upon the unified structure.

Another exemplary embodiment of the disclosed subject matter is a computerized apparatus having a processor, the processor being adapted to perform the steps of: receiving a signal; extracting audio features from the signal; performing acoustic level processing on the audio features; receiving additional data; extracting additional features from the additional data; fusing the audio features and the additional features into a unified structure; receiving a Hidden Markov Model (HMM); and performing a quantum search over the features using the HMM and the unified structure. Within the apparatus the quantum search is optionally a dynamic quantum search. Within the apparatus, the processor is optionally adapted to perform the following steps when performing the dynamic quantum search: for each time window performing; initializing scores for each predecessor word and time pointers; performing time alignment of the scores based on dynamic programming; propagating back the time pointers; and pruning branches representing irrelevant paths; and for each successor word performing: converting a search space into a quantum search space; and determining a most probable predecessor word and time boundaries thereof; storing the predecessor word or an indication thereof; and storing the time boundaries. Within the apparatus the additional data is optionally visual data of a speaker associated with the signal. Within the apparatus processing the additional data optionally comprises image processing. Within the apparatus the processor is optionally further adapted to perform the steps of: receiving an indication of a location associated with the signal; using the indication for adapting a model in accordance with the location; and using the model in the quantum search. Within the apparatus the model is optionally an acoustic model or a language model. Within the apparatus the processor is optionally further adapted to perform the steps of: receiving a training signal; extracting training audio features from the training signal; performing acoustic level processing on the training audio features; receiving additional training data; extracting additional training features from the additional training data; fusing the training audio features and the additional training features into a unified structure; and creating the HMM based upon the unified structure.

Yet another exemplary embodiment of the disclosed subject matter is a computer program product comprising a computer readable storage medium retaining program instructions, which program instructions when read by a processor, cause the processor to perform a method comprising: receiving a signal; extracting audio features from the signal; performing acoustic level processing on the audio features; receiving additional data; extracting additional features from the additional data; fusing the audio features and the additional features into a unified structure; receiving a Hidden Markov Model (HMM); and performing a quantum search over the features using the HMM and the unified structure.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart of steps in a method for automatic speech recognition;

FIG. 2 is a schematic illustration of delta array calculation for obtaining the most probable phoneme sequence, and state transition matrix and state chart;

FIG. 3 shows a flowchart of steps and illustrative example of delta array calculation, in accordance with some exemplary embodiments of the disclosed subject matter;

FIG. 4 shows a block diagram of components of a speech recognition apparatus, in accordance with some exemplary embodiments of the disclosed subject matter;

FIG. 5 shows a flowchart of steps in a method for training a multimodal speech recognition model, in accordance with some exemplary embodiments of the disclosed subject matter;

FIG. 6 shows a first flowchart of steps in a method for multimodal speech recognition, in accordance with some exemplary embodiments of the disclosed subject matter;

FIG. 7 shows a flowchart of steps in a method for multimodal speech recognition, in accordance with some exemplary embodiments of the disclosed subject matter;

FIG. 8 shows a flowchart of steps in a method for dynamic language model adaptation, in accordance with some exemplary embodiments of the disclosed subject matter;

FIG. 9 is a flowchart of steps in a method for dynamic quantum Viterbi search, in accordance with some exemplary embodiments of the disclosed subject matter; and

FIG. 10 shows a block diagram of components of an apparatus for multimodal speech recognition, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block or blocks in the block diagram.

These computer program instructions may also be stored in a non-transient computer-readable medium that can direct a computer or other programmable data processing apparatus to function in a particular manner, such that the instructions stored is in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the time consumption of speech to text common techniques, which makes them unusable for many applications. If transcribing a particular audio signal takes more than a fraction of the audio signal length, then transcribing large volume of signals, as may be required by call centers, service centers, security services or others, is impractical.

In another example, it is currently impossible to convert free speech into text in standalone embedded devices, and the devices have to connect to external computing platforms in order to complete such tasks.

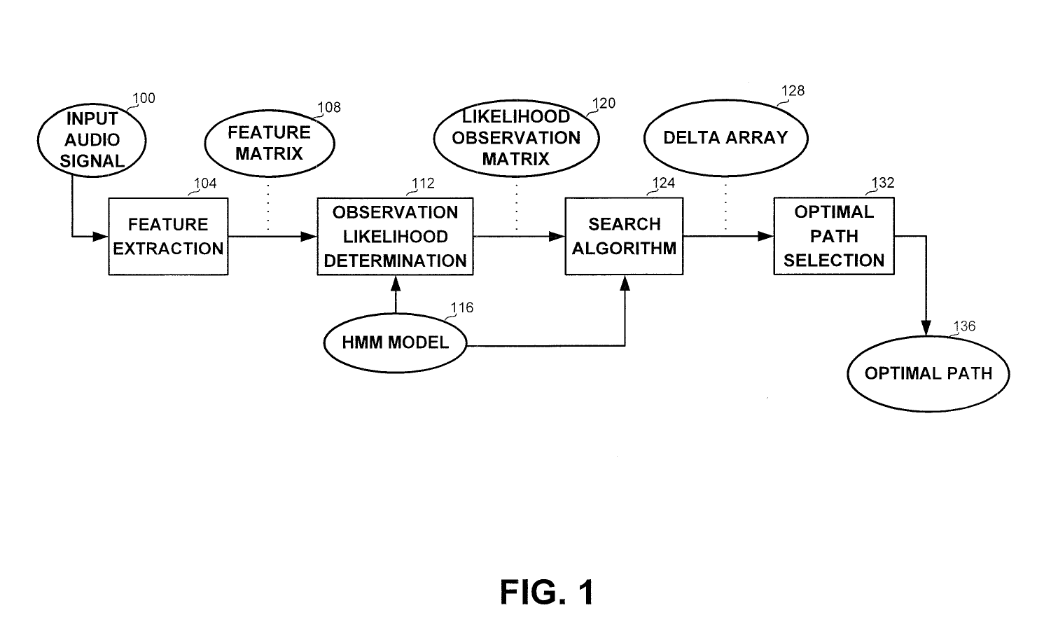

As detailed in association with FIG. 1 below, some known S2T methods comprise applying a Viterbi search algorithm for calculating a delta array indicating for each phoneme at each time frame, the probability that the phoneme was spoken at the respective time. The delta array is calculated using an observation likelihood matrix which indicates for each phoneme the likelihood it was spoken at the time frame, without taking into account other time frames) as may be obtained, for example, from a Gaussian Mixture Model, and a classification engine such as a Hidden Markov Model (HMM) which provides the distribution and transition probabilities between phoneme and states combinations.

Using traditional techniques, the complexity of the Viterbi algorithm is usually in the order of magnitude of Tᵣ²′ i.e., (Tᵣ²), wherein Tᵣ is summation over all words in a dictionary, of the number of phonemes in each word multiplied by the number of states each phoneme can assume (typically three states in the recognition phase and five states during the training phase including start and end states. The transition probability between the first and second states is the entry probability of the phoneme, and the transition probability between the fourth and fifth states is the exit entry probability of the phoneme).

Another technical problem relates to difficulties in using additional sources of information for enhancing speech recognition. One such source of information may include visual capturing of the person or persons whose speaking it is required to recognize. The visual capturing may include the person's lips area, which may provide helpful information such as selecting a phoneme from a number of options, identifying that the person is not speaking and that the audio is of another speaker, or the like. Yet another source of information may relate to indications of the location of the speaker, as may be obtained by any positioning system, such as a Global Positioning System (GPS) embedded in many mobile devices.

Yet another technical problem is the tradeoff that generally exists between time computational requirements, memory space requirements and memory access time. For example, in some cases a significant portion of the computations required for a process may be performed offline and the results may be stored, prior to the time at which information is actually required. However, since the particular circumstances that will be valid at runtime are not known a-priori, the computed data may have to include many cases, and is likely to consume significant storage space, although many of the cases may be of low or zero probability. Then in runtime, when specific information is required, although the computation time is reduced due the offline preparations taken, it may still take a long time to access and fetch the required information, due to the significant stored volume. If, however, less data is stored and some computation may be required online, access time may be shorter and the total time required in runtime may be shorter.

One technical solution comprises the application of a quantum search technique to the Viterbi algorithm, thus reducing the complexity of the algorithm.

In order to apply quantum search, the searched data has to be converted into quantum bits (qubits) upon which the quantum search can operate. The observation likelihood matrix which relates to the audio to be transcribed, may only be converted at real time. However, the Hidden Markov Model, which is a very large data structure, can be converted offline and stored, so that this conversion does not require computing resources at recognition time.

Another technical solution relates to incorporating data from other sources when training and when building the search space. For example, instead of using only audio data, audio-visual data may be used, which comprises also visual data for example the face of the person who speaks, such that features associated for example with the lip movements may also be extracted, added to the search space and searched when speech is to be recognized. Additionally or alternatively, location data, such as data obtained from a Global Positioning System (GPS) may be used, possibly in conjunction with a database associating the coordinates with a specific location or location type. An appropriate lexicon may then be assumed, which comprises relevant probabilities of words. For example, if the coordinates are associated with a hospital, then medical terms may have higher probability then if the location is associated with a bank. In addition, the location may be used for assuming a local accent, and adjusting the used acoustic model accordingly. It will be appreciated that if the speaker in an audio signal or part thereof is known, an acoustic model associated with the speaker may be used or adapted.

Yet another technical solution comprises reducing the volume of the search space built for the quantum search. In applications involving small vocabularies, such as recognizing digits, Automated Voice Response (AVR) systems or others, the search space is relatively small and can be built a-priori and used efficiently in runtime. However, in large vocabulary applications, the search space may not be built and stored a-priori due to its large size which requires significant storage volume and to the significant search time required in runtime. This problem may even worsen if multimodal input is used, which may further increase the search space due to the additional features extracted and used. Thus, the search space may rather be created in runtime in a dynamic manner. When the system is at a particular state comprising a combination of one or more phonemes, a search space comprising only the relevant states which can be reached from the current state is constructed. For example, if it is realized that the current word starts with a ‘t’, the search space may relate only to words that start with a ‘t’. Optionally, the search space may also relate to words that start with ‘p’, ‘d’, or ‘b’ which may be confused with ‘t’, but most other states may be omitted.

It will be appreciated that combining the dynamic quantum search with using the additional information may further enhance the performance, by reducing the search space while maintaining relevant branches.

One technical effect of the disclosed subject matter relates to performing the Viterbi search at O(Tr*sqrt(Tr)) complexity per each time frame, which is lower than the complexity enabled by prior art techniques. This provides for better performance using the same HMM model, which may account for processing more audio signals or channels with the same computing resources. Alternatively or additionally, more detailed phonetic models having more phonemes, or more detailed linguistic models having more words may be used. In yet additional embodiments, the used search beam may be extended, thus searching a larger number of paths in the delta array, which in turn accounts for higher accuracy transcription without requiring exponentially more time or more computing resources.

Another technical effect of the disclosed subject matter relates to implementing speech recognition in real time using limited hardware resources such as processing power or memory, such as those available in embedded systems. For example, a handheld device such as a mobile phone may be able to recognize speech using only its own processing resources without having to use additional resources such as resources provided by cloud computing. This may enable faster recognition as well as recognition when the device is offline and not connected to any external computing resource.

Yet another technical effect of the disclosed subject matter relates to enhancing speech recognition by improving the tradeoff between storage volume, fetching time, and computation time. The speech recognition quality may also be improved, since building a dynamic and more efficient search space provides for adding multiple relevant branches to the search space.

The speech recognition quality may also be enhanced by selecting an appropriate acoustic or language models, which may be determined using the location information. It will be appreciated that if the speaker is known, which may be the case in many situations, including the person speaking with his or her telephone, then an acoustic model specifically adapted to the person may be used, which greatly enhances the recognition.

Referring now to FIG. 1, showing a flowchart of steps in a method for automatic speech recognition.

An input audio signal 100 may be received from any source and via any channel, for example from a microphone, from broadcasting, retrieved from storage, received over a network connection or the like. The signal may be received as a file of known length or as a stream.

Input signal 100 is input into a feature extraction step 104. The features are typically arranged into feature vector, wherein each feature vector represents the features at a time window. Typically, the time windows may be of 5-100 mSec and may overlap, e.g., 20 mSec with 10 mSec overlap between consecutive windows.

The features may be Mel-frequency cepstrum coefficients (MFCC) features, frequency cepstrum coefficients (FCC) features, or the like. For example, when using MFCC features, 39 features may be extracted, wherein 13 features relate to energy, other 13 features relate to the first derivative of the energy, and the remaining 13 features relate to the second derivative of the energy. However, any other feature set of any required length may be used.

The output of feature extraction step 104 is feature matrix 108, in which each column represents the features extracted from a particular time window of the audio input.

Observation likelihood determination step 112 uses feature matrix 108, together with state probabilities that may be obtained from a Gaussian Mixture Model (GMM), to generate likelihood observation matrix 120. Likelihood observation matrix 120 represents for each feature vector and for each state of phoneme the probability that the feature vector is associated with the particular phoneme, In some embodiments, likelihood observation matrix 120 may comprise a row for each phoneme or each word and a column for each time window, such that each entry represents the likelihood or the probability that the specific state of phoneme appeared in the specific time window.

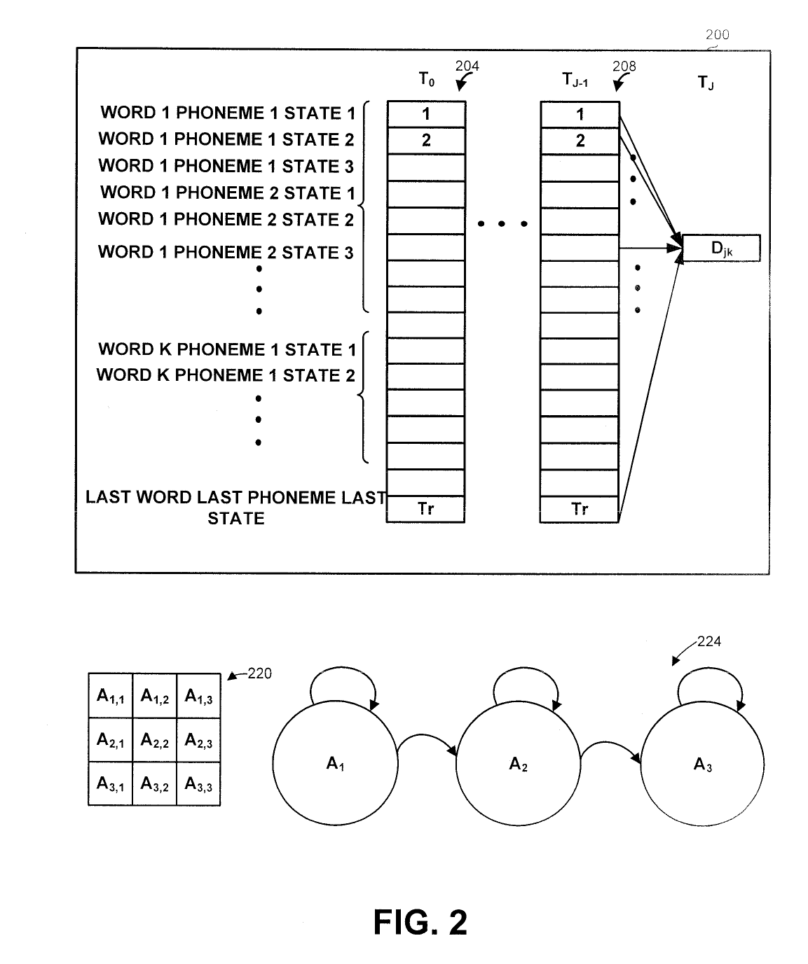

HMM 116 may comprise phoneme and state transition information, which may be language-dependent. HMM 116 is further detailed in association with FIG. 2 below.

Likelihood observation matrix 120 and HMM model 116 are input into a search algorithm 124 such as Viterbi search algorithm to generate delta array 128. In some embodiments delta array 128 may comprise a row for phoneme and state combination within each word, such that delta array 128 may comprise the total number over all words of the number of phonemes in the word*number of states rows. Typically, each phoneme can be at any of three states, although during training of a HMM five states may be used. The first and the last states are used for determining probability of starting and ending a word. Delta array 128 may also comprise a column for each time window, such that each entry in delta array 128 comprises the probability that the specific phoneme at the specific state as part of a specific word was spoken at the particular time window.

The Viterbi algorithm is based on the assumption that the optimal sequence relating to time window 0 to time window n+1 comprises the optimal sequence at time window 0 to time window n, so that no backward correction is performed.

The value of each entry in a particular column is thus calculated based on the maximum product between each entry in the previous column and the transition probability between the respective phoneme and state combinations, multiplied by the relevant probability in likelihood observation matrix 120.

The transition probabilities may be expressed, for example, as a transition matrix representing the probability of transition from one phoneme and state combination to another, as detailed below.

Delta array 128 may then be input into optimal path selection step 132, which starts from the last time frame, and selects the most probable phoneme and state combination for that time frame as expressed in the entry of the last column of delta array 128 having the highest value. The algorithm then moves back to the entry in the previous column from which the selected entry in the last column got its maximal value, in accordance with formula (I) below, and so on until the first time frame of the segment. Alternatively, the optimal path may be provided during the search algorithm such that once a column of delta array 128 is completed, the phoneme and state combination having the highest probability is provided.

Referring now to FIG. 2, showing a schematic illustration of delta array calculation for obtaining the delta array, from which the most probable phoneme sequence can be deduced.

Delta array 200 comprises a row for each phoneme and state combination in each word. It will be appreciated that a more complex model can be used, relating for example to biphones (a sequence of two phonemes and multiple states) or triphones (a sequence of three phonemes and multiple states), which require a significantly larger number of rows.

Delta array 200 comprises a column for each time window such as column 204 relating to some arbitrary time T₀, and column 208 relating to sometime Tⱼ₋₁, later than T₀. Each entry Dⱼₖ comprises a probability that the corresponding phoneme and state combination (j) was spoken within the relevant word at time window k.

Matrix 220 and state chart 224 are two representations of state transitions associated with a particular phoneme A. Each entry A_{i,j} in matrix 220 represents the probability of transition of phoneme A from state i to state j, wherein i and j are between 1 and 3, and i<=j (i.e., transition is always to the same state or to a more advanced state). State diagram 224 provides another representation of the transition probabilities, demonstrating that the phoneme can remain in the same state or transit to the next state. State diagram 224 does not show the start and end states for the phoneme since these are not used in recognition.

A Hidden Markov Model comprises a matrix such as matrix 220 (or any other corresponding data structure) for each phoneme in each word.

Each phoneme and state combination is also associated with a probability derived from a probability density function. Such probability may be obtained, for example, from a Gaussian Mixture Model (GMM) that receives the feature vector at the relevant time frame and outputs the probability for a particular phoneme state.

The probability in entry Dⱼₖ in delta array 200 thus indicates the likelihood that the phoneme and state combination may have indeed been identified at the time window, based on the standalone likelihood of the relevant feature vector associated with the phoneme state, the probabilities of previous phoneme state combinations, and the is transition probabilities from the previous combinations, The standalone likelihood may be derived from the feature vector and the GMM. The transition probabilities between phoneme and state combinations are derived from the HMM.

The Viterbi algorithm considers at each stage only the maximum probability of the current phoneme state, and the transfer probabilities to that state from previous stage Thus, entry Dⱼₖ may be calculated as:

$${D}_{jk} = [ {max}_{i = 1 … n} ( {D}_{j - 1 , i} * Tr ( i , k ) ) ] * {B}_{jk}$$

wherein D_{j-1,i} represents the value at row i in a previous column, Tᵣ(i, k) represents the transition probability from phoneme and state combination i to phoneme and state combination k, as expressed in the transition matrix for the same phoneme, and in the linguistic model for transition between different phonemes and optionally different words, and B_{j,k} represents the probability that phoneme and state j were identified at time window k, as expressed in the likelihood observation matrix.

Thus, determining entry Dⱼₖ takes into account the features extracted at time j, as well as the maximum between the multiplications of probabilities for phoneme and state combinations at time j−1, and the transition probability between the combinations. Finding the maximum product is of complexity O(Tᵣ²) and is a major processing resources consumer in speech recognition.

The probabilities of transition between phonemes are determined based on the exit probability of the previous phoneme and the entry probability of the next phoneme, as may be determined also during training and may be expressed by the transition probability between the first and second states of the phoneme (exit probability), and the transition probability between the fourth and fifth states (entry probability).

It will be appreciated that since each phoneme and each phoneme combination may repeat in multiple words, the same sequence of probabilities may repeat for a multiplicity of words having similar parts. For example the probabilities of the first phonemes and state combinations in the words “meaningful” and “meaningless” will be substantially the same.

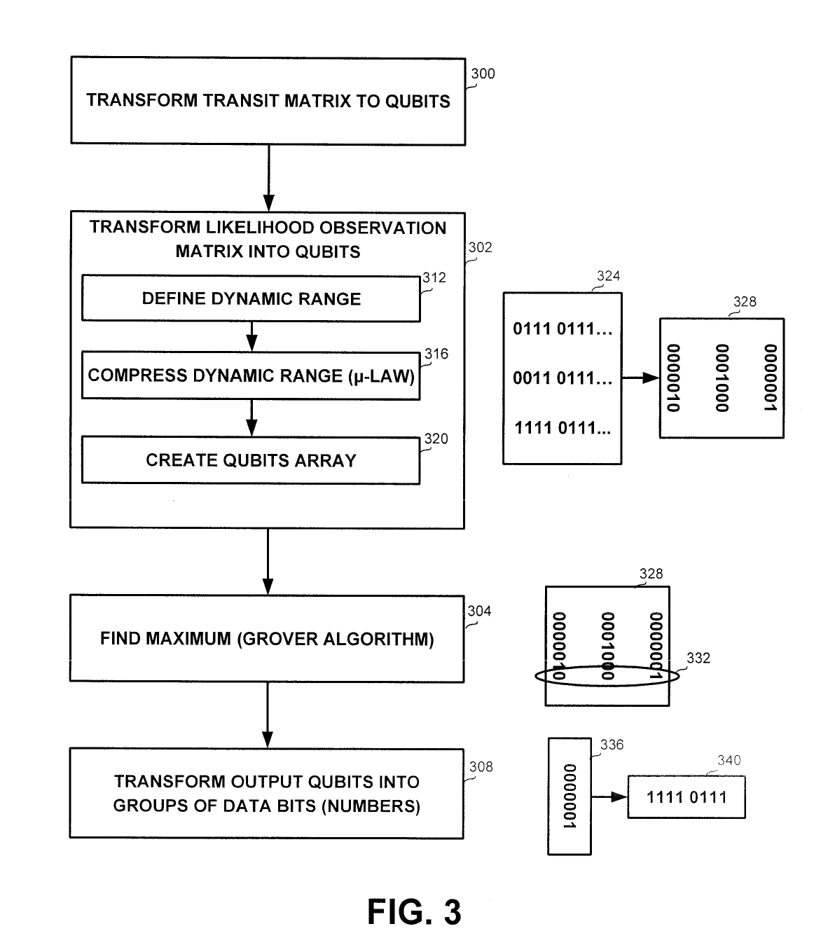

Referring now to FIG. 3, showing a flowchart of steps in a method, and illustrative example for determining a maximum value as required in formula (1) above, using quantum search. The method displayed in the flowchart may be used for determining the maximal product during the delta array calculation, and/or determining the phoneme and state having the maximal value when retrieving the optimal path, i.e. the phoneme sequence.

On step 300, the HMM model, including the transition matrix of states for each phoneme in each word is transformed into qubits, which are the basic units used by quantum search algorithms. The transformation is further detailed in association with step 302 below. Since the HMM model is fixed for a particular environment and does not change in accordance with the audio signal, the model may be converted to qubits offline and stored for multiple recognitions, rather than be transformed online for each recognition. The transformation complexity of the model may be 2*F*Tr*N*O(A) steps, wherein F is the number of features, Tr is the total number of state and phoneme combinations, N is the number of used Gaussians for GMM, and O(A) is the complexity of the conversion algorithm. However, this transformation is performed once and may be performed offline, thus it does not add to the online recognition complexity.

On step 302, the data related to the audio signal, including data related to the likelihood observation matrix is transformed into qubits as well. The likelihood observation matrix is the probability for each phoneme to have been present at the particular time frame, based on the feature vector extracted for that time frame.

Transformation into qubits step 302 may include substep 312 of defining a dynamic range for the numbers to be converted, substep 316 for compressing the dynamic range, using for example Haw, and substep 320 for creating the qubits array.

For example, the three eight-bit numbers shown in data 324 which may be part of a larger number of groups, are transformed into 7-bit numbers shown in data 328, while preserving partial order (in FIG. 3 the MSB appears on the right-hand side of the number), such that the numbers are orthogonal. Thus, 01110111 is transformed into 0000010, 00110111 is transformed into 0001000, and 11110111 is transformed into 0000001. This conversion is of O(A) complexity per each number, so the total complexity is of O(A)*Tᵣ.

It will be appreciated that the transformation of step 302 can be applied to the is likelihood observation matrix as extracted from the feature vectors using the GMM. Alternatively, the transformation can be adapted to receive the feature vectors and the GMM, which may also be converted to qubits offline, and to output the relevant qubits without having to first generate the likelihood observation matrix from the feature vector.

On step 304, once all data is available in qubits format, the maximum of all numbers is found, using for example Grover's algorithm. Grover's algorithm searches for a “1” in the MSBs of all numbers indicated as 332. Due to the way the numbers were selected in accordance with μ-law, it is guaranteed that there is one number having “1” at its MSB, and since the numbers are orthogonal, there is exactly one number having “1” as its MSB. In the example above, the number with an MSB of “1” is the 0000001. The complexity of Grover's algorithm is O(sqrt(Tr)) where in Tr is the total number of phoneme and state combinations for all words.

On step 308, the regular numbers may be retrieved back from the output qubits, so that they can be used in calculating the next column. However, this transformation may be omitted if the next column is also to be determined using qubits. In the example above, the 0000001 is transformed back to 11110111, so that it can be used later when retrieving the optimal path. The complexity of this conversion is also O(A). The overall complexity of determining the entries of each column is thus the maximum between the conversion complexity of step 302, and sqrt(Tr) for each time window. 5

It will be appreciated that since the search step is the most resource consuming step in extracting the phoneme sequence, reducing the complexity of this step practically reduces the overall time of the algorithm. For example, a reduction in a factor of 8 had been observed in tests performed on ASP system with double precision numbers (64 bit based) using the quantum search for determining the delta array, vs. conventional Viterbi search. In the test routines was use same 2.5-3.5 sec speech sources and was observed almost same recognition accuracy.

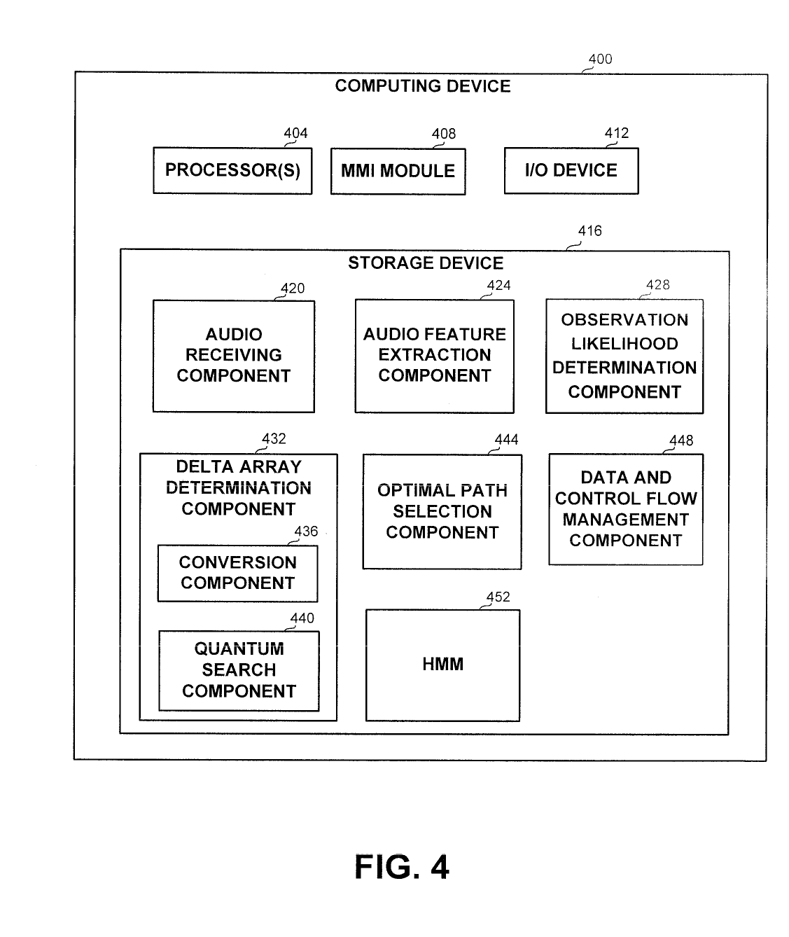

Referring now to FIG. 4, showing a block diagram of components of an apparatus for speech recognition.

The apparatus comprises a computing device 400, which may comprise one or more processors 404. Any of processors 404 may be a Central Processing Unit (CPU), a microprocessor, an electronic circuit, an Integrated Circuit (IC) or the like. Alternatively, computing device 400 can be implemented as firmware written for or ported to a specific processor such as digital signal processor (DSP) or microcontrollers, or can be implemented as hardware or configurable hardware such as field programmable gate 20 array (FPGA) or application specific integrated circuit (ASIC). Processors 404 may be utilized to perform computations required by comptuing device 400 or any of it subcomponents.

In some exemplary embodiments of the disclosed subject matter, comptuing device 400 may comprise MMI module 408. MMI module 408 may be utilized to provide communication between the apparatus and a user for providing input, receiving output or the like. For example. MMI module may be related to a capturing application and/or to presenting recognition results.

In some embodiments, computing device 400 may comprise an input-output (I/O) device 412 such as a terminal, a display, a keyboard, a microphone or another audio input device or the like, used to interact with the system, to invoke the system and to receive or view the results.

Computing device 400 may comprise one or more storage devices 416 for storing executable components. Storage device 416 may also contain data during execution of one or more components. Storage device 416 may be persistent or volatile. For example, storage device 416 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 416 may retain program code operative to cause any of processors 404 to perform acts associated with any of the steps shown in FIG. 1 or FIG. 3 above, for example receiving audio signal, extracting features, determining likelihood observation matrix, searching, or the like.

The components detailed below may be implemented as one or more sets of interrelated computer instructions, executed for example by any of processors 404 or by another processor. The components may be arranged as one or more executable files, dynamic libraries, static libraries, methods, functions, services, or the like, programmed in any programming language and under any computing environment. Storage device 416 may comprise or be loaded with one or more of the components, which can be executed on computing platform 400 by any one or more of processors 404. Alternatively, any of the executable components may be executed on any other computing device which may be in direct or indirect communication with computing platform 400.

Storage device 416 may comprise audio receiving component 420 for receiving audio signals. Audio signals can be received from any capturing device such as a microphone or broadcasting, from a storage device storing previously recorded or generated audio, from another computing device over a communication channel, or from any other source. The audio signals may be received as files, streams, or the like.

Storage device 416 may also comprise audio feature extraction component 424 for extracting one or more features from the audio at each time frame. The features may be MFCC, FCC or others, and the time window can be of any required length. It will be appreciated that a tradeoff exists between the required computing resources and the length of the time windows, such that fewer computing resources are required hen processing the signal in longer time windows, but longer time windows, in which a single feature vector represents each time window, provides lesser results.

Yet another component loaded to storage device 416 may be observation likelihood determination component 428 for determining an observation likelihood matrix, which represents probabilities associated with each phoneme and state combinations for each time frame, based on the extracted features and probability indications, such as a Gaussian Mixture Model.

Storage device 416 may also comprise or be in association with delta array determination component 432 for determining the probabilities of each phoneme and state combination at each time frame, based on the likelihood matrix and a transition matrix which may also be part of the HMM. Delta array determination component 432 may comprise a conversion component 436 for converting between numbers and qubits as detailed in association with step group 302 and step 308 of FIG. 3 above, and quantum search component 440 which searches for a maximum among a group of qubits, using for example Grover's algorithm or another algorithm of the same or better performance, as detailed in association with step 304 of FIG. 3 above.

Optimal path selection component 444 which may also be loaded or stored on storage device 416 is adapted to select for each time frame the phoneme and state combination having the highest probability. The sequence of selected phonemes may be presented as the result of the recognition. Optimal path selection component 444 may be implemented as part or in connection with delta array determination component 432 detailed above.

Storage device 416 may also comprise data and control flow management component 448 for managing the flow of information and control between the components, for example transferring an audio signal received by audio receiving component 420 to feature extraction component 424, providing the output, or the like.

Storage device 416 may also comprise one or more data structures, such as one or more HMM models 452 or GMM models for speech recognition. Device 416 can store different models trained on speech with different characteristics, different languages, or the like.

It will be appreciated that storage device 416 can comprise additional components, such as audio enhancement component for improving the audio quality, removing noise, removing silence periods, or the like. Storage device 116 can also comprise language models for adapting the resulting phoneme sequence into words while considering linguistic characteristics such as word frequency, or the like.

The disclosed method and apparatus provide for enhanced speech recognition using HMM. By using quantum search methods, the recognition is improved from having complexity of O(Tr*Tr) to O(TR*sqrt(Tr)), such that higher accuracy can be achieved with the same resources and/or larger volume of audio can be processed. The performance improvement may benefit from transforming the HMM to qubits offline, such that only the audio-related data needs to be transformed online. The improved complexity may enable and embedded device such as a hand held device to perform is speech recognition without having to utilize external resources such as an external; server, a cloud computing network or the like. This may enable a mobile phone user, for example, to use the full range of speech activation features even when the device is offline.

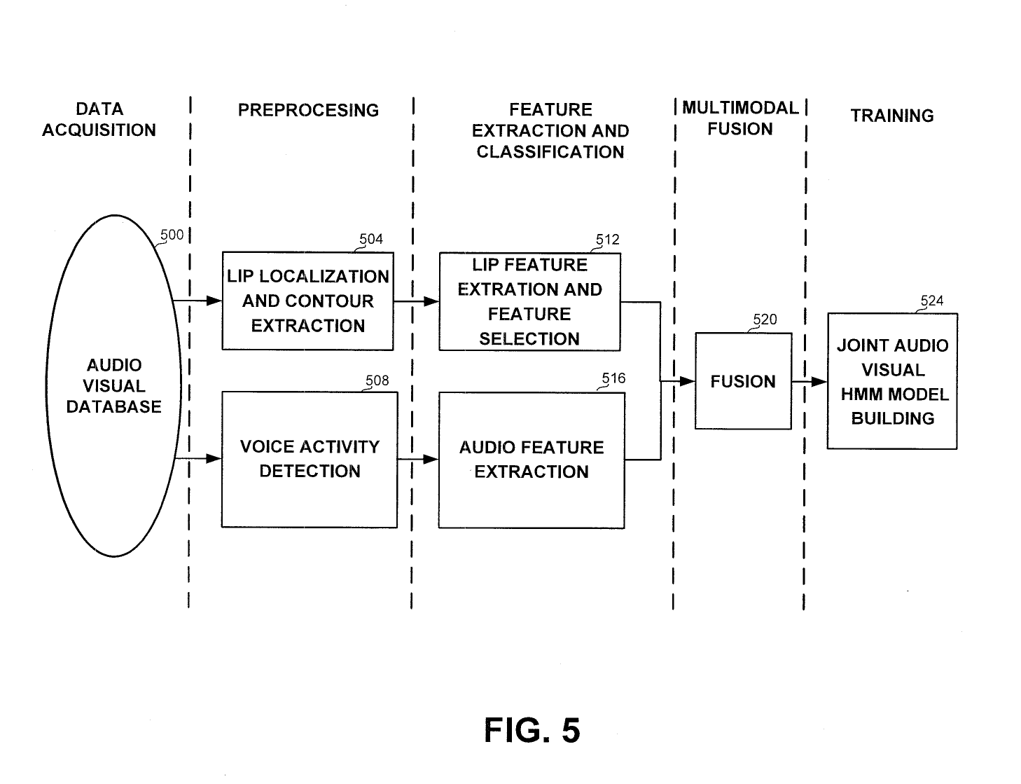

Referring now to FIG. 5, showing a method for speech recognition training, in an environment providing also visual capturing of one or more speakers.

Given an audio visual database 500 of captured voice and images, it may undergo preprocessing, feature extraction and selection, multimodal fusion, and training. Audio visual database 500 may be captured using a video capturing device, which captures the audio as well as the visual happenings at a scene. The visual part may vary and show every speaker when speaking, or may be fixed and show a larger image including all speakers, or any combination thereof. During some of the capturing the face of a speaker may not be shown.

During preprocessing, the video part of the capturing may undergo lip localization and contour extraction step 504, in which the lips of a speaker are identified and their contour is extracted, so there is no further need to analyze the full image, but only the speaker lips' area.

During preprocessing, the audio part may undergo voice activity detection step 508, for removing silent segments, areas in which the audio contains music or other non-speech sounds, or any other pre-processing such as speaker separation, noise removal, or the like.

During feature extraction and classification stage, the lips area as extracted on step 504 may undergo lip feature extraction and selection step 512. The features may include any features relevant for image processing, such as identifying open or close mouth, identifying stretching or puckering of the lips, or the like.

The audio part, after being preprocessed, may also undergo audio feature extraction on step 516. It will be appreciated that if the audio has been separated due to multiple speakers, the flow may relate to the speech of each speaker separately.

The features are typically arranged into feature vector, wherein each feature vector represents the features at a time window. Typically, the time windows may be of 5-100 mSec and may overlap, e.g., 20 mSec with 10 mSec overlap between consecutive windows.

The audio features may be Mel-frequency cepstrum coefficients (MFCC) features, frequency cepstrum coefficients (FCC) features, Power-Normalized Cepstral Coefficients (PNCC), wavelet, multi wavelet or any other feature set, in accordance with the expected performance. For example, when using MFCC features, 39 features may be extracted, wherein 13 features relate to energy, other 13 features relate to the first derivative of the energy, and the remaining 13 features relate to the second derivative of the energy. However, any other feature set of any required length may be used.

Once features are extracted, the features may undergo fusion step 520, in which according to the time stamps associated with the extracted feature values, the visual and the audio features are synchronized or correlated and unified into a multimodal structure. For example, open sounds like “A” are likely to correspond to image features indicting an open mouth, and such corresponding features may be associated with the same time points or time slots.

On step 524, a joint audio visual HMM model 524 is built which may provide the distribution and transition probabilities between phoneme and states combinations, in which the phonemes and states are represented by their audio as well as their visual features.

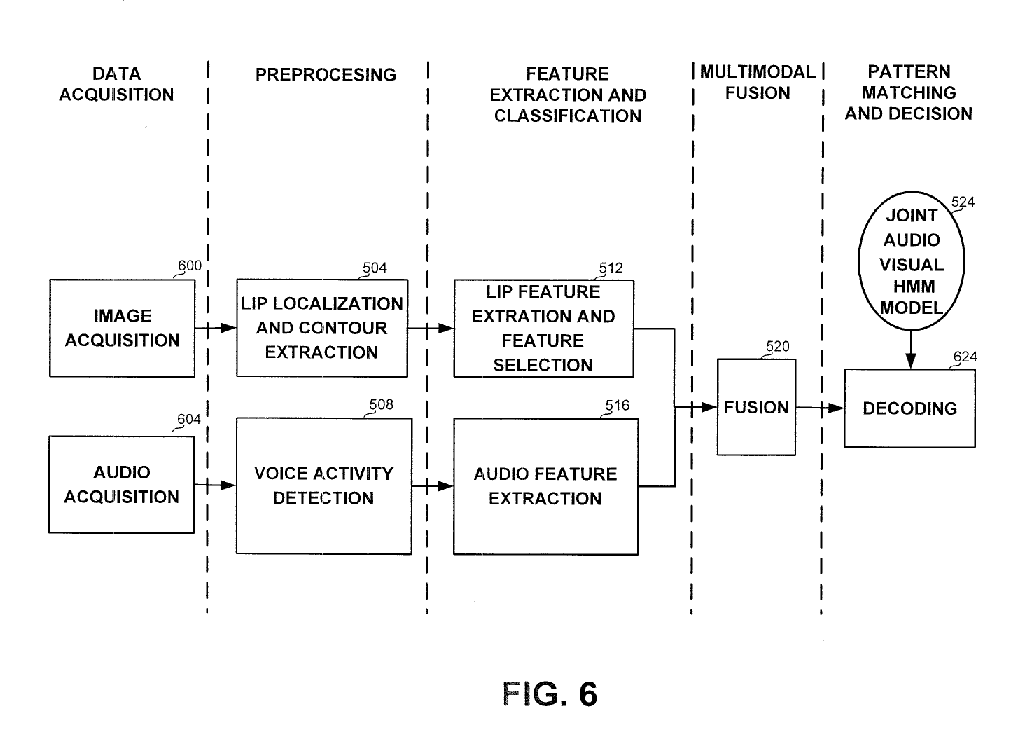

Referring now to FIG. 6, showing a flowchart of steps in a method operative in first architecture of speech recognition, in accordance with some embodiments of the disclosure.

On step 600 image acquisition of one or more speakers is performed, and on step 604 audio acquisition is performed. In some embodiments, image acquisition 600 and audio acquisition 604 may be performed simultaneously, by one or more devices, such as a video camera. However, if captured together, the image and the audio may then be separated for separate processing.

The images may then undergo lip localization and contour extraction step 504 and lip feature extraction and selection step 512, and the audio may undergo voice activity detection step 508 and audio feature extraction step 516, as described in association with FIG. 5 above. The image features and the audio features may undergo fusion step 520 as also described in association with FIG. 5 above.

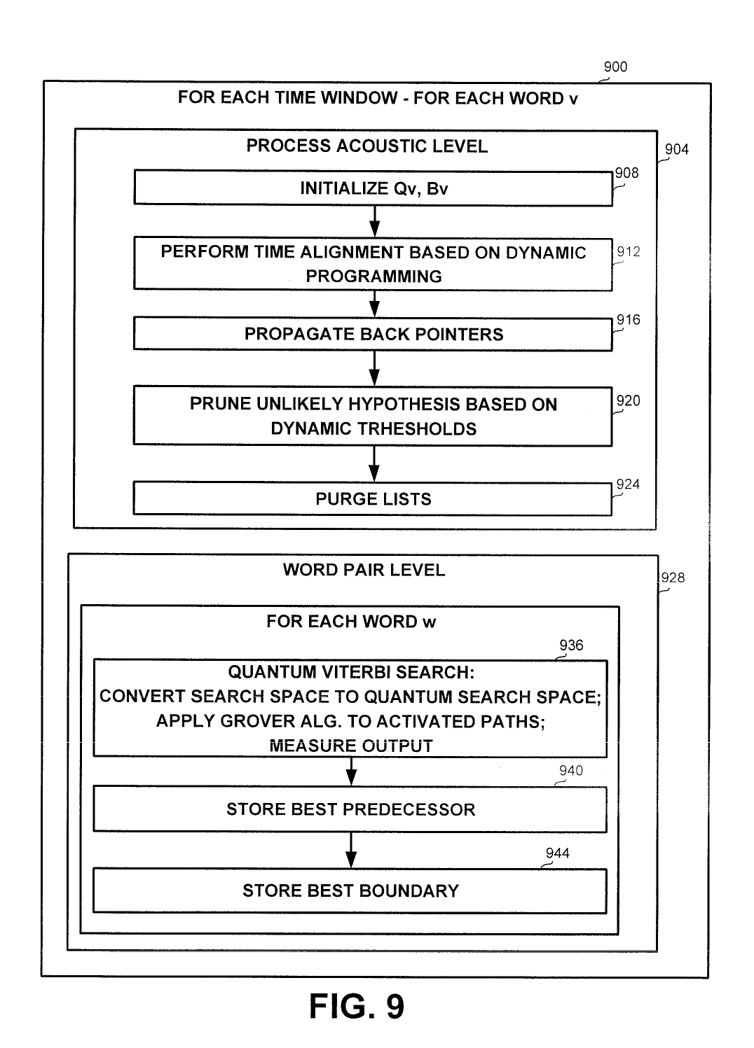

The fused features, as well as joint audio visual HMM model 524 constructed in training the system, may then be used in decoding step 624, which may be implemented as quantum decoding described in association with FIG. 3 above. In some embodiments, decoding step 624 may be implemented as dynamic quantum Viterbi decoding, detailed in FIG. 9 below.

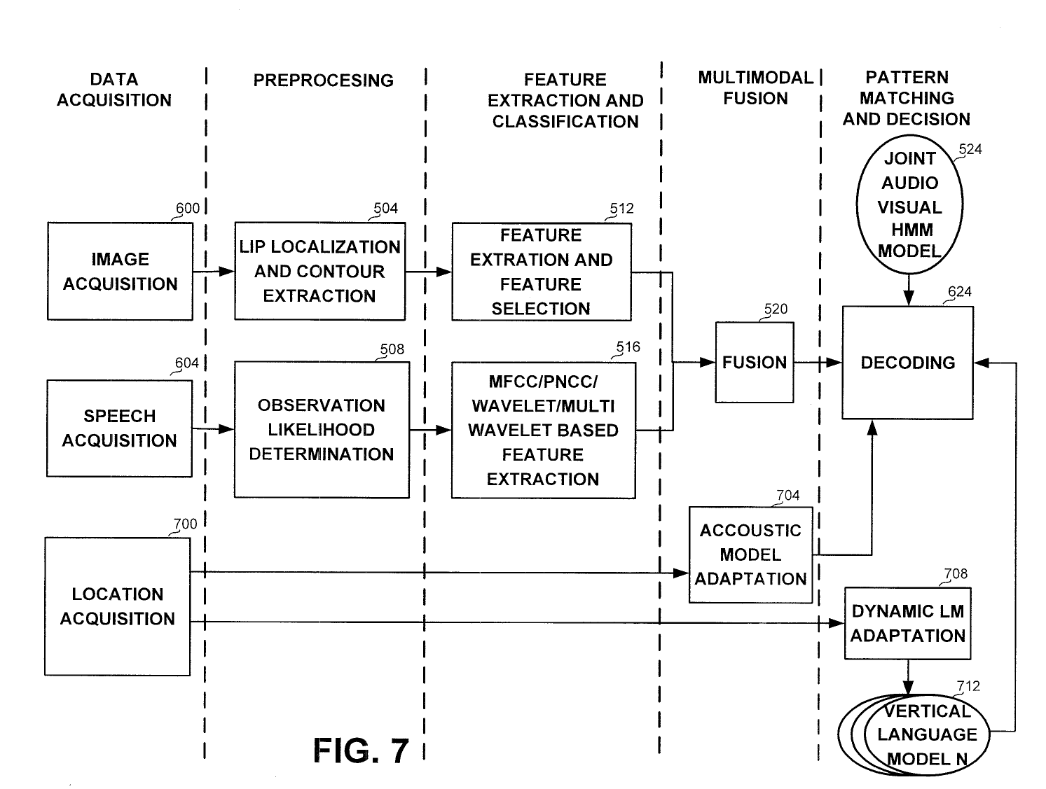

Referring now to FIG. 7, showing a flowchart of steps in a method operative in a second architecture of speech recognition, in accordance with some embodiments of the disclosure.

In addition to the information sources of FIG. 6, the method shown in FIG. 7 may also utilize location indications as acquired on location acquisition step 700. The location indications may be obtained using for example a GPS system, user-entered indications of the locations in which the image and the audio are captured, location indications obtained by comparing captured images to a bank of images, or the like.

The images may then undergo lip localization and contour extraction step 504 and lip feature extraction and selection step 512, and the audio may undergo voice activity detection step 508 and audio feature extraction step 516, as described in association with FIG. 5 above. The image features and the audio features may undergo fusion step 520 as also described in association with FIG. 5 above.

The location indications may be used in acoustic model adaptation step 704, in which location-related features of the speech may be used in adapting the used acoustic model. This adaptation may or may not take place if the speaker is known and a specific acoustic model is available for the speaker, in which the specific model will be used in recognizing the speech, with or without the adaptation. For example, if certain sounds are pronounced differently, or are not pronounced in an accent frequent in a certain area, the phonemes associated with these sounds may be removed or may be assigned low probabilities.

The location indications may also be used in dynamic language model adaptation step 708, in which the language model is adapted to reflect or include a specific lexicon. For example, if the location indication is associated with a hospital, medical terms may receive higher likelihood, while if the location indication is associated with a bank, financial terms may receive higher likelihood. Thus, dynamic language adaptation step 708 may adapt and enhance one or more language models 712.

It will be adapted that the language model may be updated occasionally, at predetermined times, when a new location is encountered, or the like, and it may not be necessary to update it for any new speech recognition task. In other cases the relevant language model may be identified and used as is.

The relevant and enhanced language model may then be used in decoding step 624 as detailed in association with FIGS. 2-4 above. In some embodiments, decoding step 624 may be a dynamic quantum Viterbi decoding as detailed in association with FIG. 9 below.

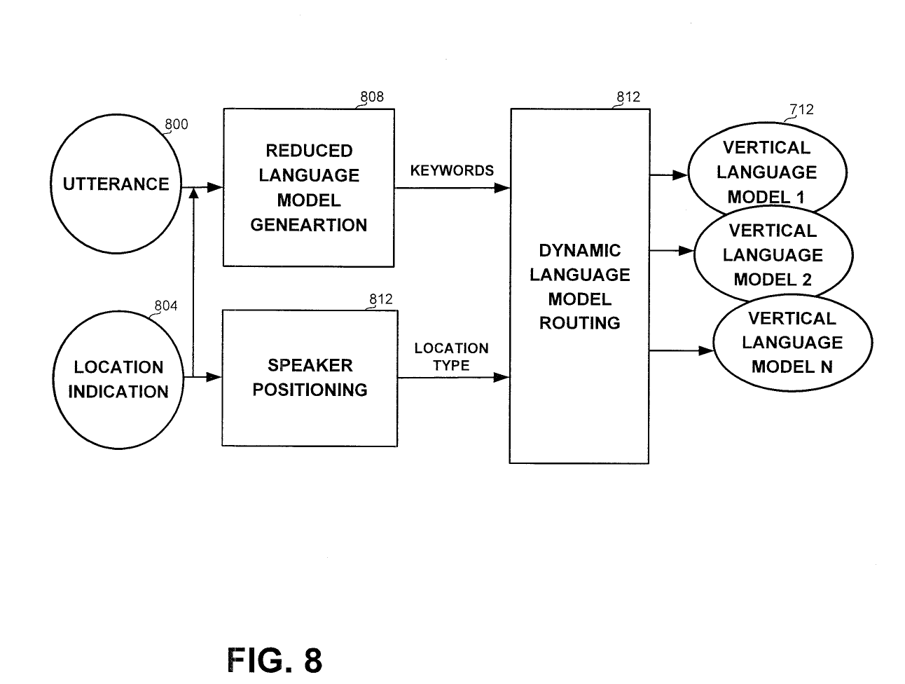

Referring now to FIG. 8, showing steps in a flowchart of a method for dynamic language adaptation, as used for example on step 708 of FIG. 7.

The method may receive as input utterance 800, which may comprise a current speech it is required to recognize, a general speech or an utterance known to be associated with the location indication or the like. The utterance may be used for keyword spotting, of words belonging to a small lexicon of keywords, for determining a domain relevant for the speaker or the audio, and generating a reduced language model on step 808.

The location indication may also be used for speaker positioning step 812, for example determining whether the speaker is at a hospital, a bank, a retail environment, a university campus, or the like.

The keywords spotted on reduced language model generation step 808, or the speaker's position obtained by speaker positioning step 808 may then be used in dynamic language routing model step 812, for determining one or more vertical language models 712 to use, and optionally enhancing the selected model.

Referring now to FIG. 9, showing a flowchart of steps in a method for dynamic speech recognition, using dynamic quantum search.

The method is a one-pass quantum dynamic programming using a tree lexicon algorithm, i.e., a single path is used (rather than N best paths) such that once a decision has been taken about a phoneme in a particular time location, the decision is not re-visited and may be used in determination of the phonemes at later time locations. It will, however, be appreciated that the disclosure is not limited to one pass and may be extended to N-best algorithms.

Tree lexicon refers to tree organization of pronunciation whose arcs are phonemes, and is particularly used for large vocabulary, unlike linear lexicon which is more suitable for small vocabulary in which the number of transitions is smaller.

The method may employ quantum search as detailed in association with FIG. 3 above.

The method, generally referenced 900, traverses the input audio and performs the algorithm as detailed below for each time window. It will be appreciated that the time windows may overlap.

For each time window, the acoustic level is processed on step 904 for processing (tree, state) hypotheses, followed by processing word pair level on step 928 for processing word end hypotheses.

Acoustic level processing step 904 is repeated for each word v and may comprise initializing step 908 for initializing for each word the scores and times as follows:

Qᵥ(t−1;s=0)=H(v;t−1), and

Bᵥ(t−1;s=0)=t−1

wherein Qᵥ(t; s) is a score of the best partial path that ends at time t state s of the lexical tree for predecessor v; Bᵥ(t; s) is a start time of the best partial path that ends at time t state s of the lexical tree for predecessor v; and H(v; t) is the probability of word v at time t.

Acoustic level processing step 904 may comprise aligning the times of the feature vectors step 912, based on dynamic programming, for assigning each vector observed at time t to a (state, word) index pair, and propagating back pointers Bᵥ(t; s) on step 916, which may also be based on dynamic programming. The time alignment and back propagation may take place only for combinations having relatively high probability in the HMM and in the language model, such as language model 712 of FIG. 7. This will leave only a small fraction of relevant branches out of all possible branches, and may create a much smaller search space than if all options are processed.

Acoustic level processing step 904 may comprise pruning branches step 920 for removing branches of lower probability out of the relevant paths created on step 912, wherein the branches of lower probability represent irrelevant paths or unlikely hypothesis. Pruning further reduces the size of the search space and enables fast search on step 936.

Acoustic level processing step 904 may comprise purging bookkeeping lists step 924 for purging lists or other structures which are not required anymore on.

Once acoustic level processing step 904 is performed for all words, the dynamically built search space is available.

Word pair level processing step 928 comprises performing the following steps for each word w.

On step 936 search is performed on the search space created on step 904 for locating the maximal probability for word w, by considering the probability of each (v,w) pair, obtained from the probability of a possible predecessor word v, combined with the transition probability from v to w:

$$H ( w , t ) = \underbrace{max}_{v} \{ p ( w \vert v ) {Q}_{v} ( t , {S}_{w} \} \\ {v}_{0} ( w , t ) = \underbrace{argmax}_{v} \{ p ( w \vert v ) {Q}_{v} ( t , {S}_{w} \}$$

wherein H(w, t) is the probability of word w at time t, and v₀(w,t) is the word v (or the index of the word v) preceding w, which together with the transition probabilities yields this maximal probability.

Search step 936 may be performed using quantum Viterbi search, as detailed in association with FIG. 3 above, and may comprise: converting the search space is comprising the scores to a quantum search space, and applying Grover's algorithm to all activated paths for determining the most probable output, comprising the most probable predecessor word and its time boundaries.

On step 940 the best predecessor word v may be stored; and on step 944 the time boundaries, i.e., the start and end times of the word may be

v₀:=v₀(w,t)

and on step 994 the time boundaries, i.e., the start and end times of the word may be stored τ₀:=Bᵥ_{ₒ}(t, S_{w}).

It will be appreciated that search step 936 may thus be performed dynamically, based upon a dynamically generated search space. Further, the search space is constructed of qubits, such that the search is a dynamic quantum search.

It will also be appreciated that the search space is based not only on audio-related features but also on other features, such as image features or features obtained from any other modality and fused with the audio features.

It will be appreciated that the method shown in FIG. 9 may be used whether the search information is based only on audio features, or also on any additional available information, such as captured images, location information, or information obtained from any other modality and fused with the audio features.

It will also be appreciated that the disclosed method may be manipulated and enhanced as detailed for example in “Dynamic Programming Search for Continuous Speech Recognition” by Hermann Ney and Stefan Ortmanns of Lehrstuhl fur Informatik VI, Computer Science Department, RWTH Aachen University of Technology D-52056 Aachen, Germany, published on Apr. 14, 1999, update and updated on Jun. 20, 1999, incorporated herein by reference in its entirety and for all purposes.

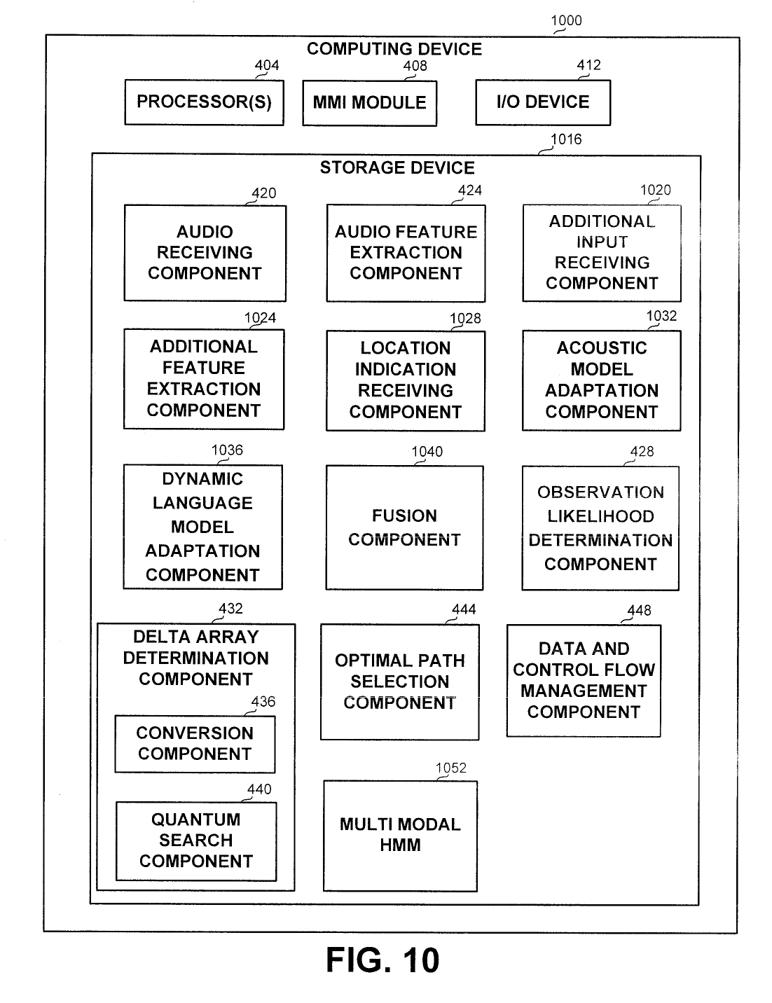

Referring now to FIG. 10, showing a block diagram of components of an apparatus for dynamic multimodal speech recognition. The apparatus may be used for training as well as for recognizing speech. Apparatus 1000 comprises components of apparatus 400 disclosed in association with FIG. 4 above, some of which may be adapted for the enhancements, as well as additional components.

Thus, storage device 1016 which may be implemented similarly to storage device 416 may also comprise additional input receiving component 1020 for receiving input in addition to the audio input, such as images, which may be provided as a sequence of video frames, and may be compresses any known mechanism, as a collection of still images, or the like.

Storage device 1016 may comprise additional feature extraction component 1024 for extracting features from the additional input. The features may correspond to the particular type of additional data obtained, for example if the additional data comprises images, then the extracted features may be image processing-related features.

Storage device 1016 may comprise additional location indication receiving component 1028 for receiving location indication, such as GPS coordinates, a location description, a location type description, or the like. In some embodiments, location indication receiving component 1028 may comprise or may be in communication with a database for obtaining further details related to the location or location type.

Storage device 1016 may comprise acoustic model adaptation component 1032 for adapting an acoustic model using location information, which may be used, for example for applying a known accent.

Storage device 1016 may comprise dynamic language model adaptation component 1036 for adapting a language model based upon the location indication. For example, the location indication may provide the location type, which may imply a specific language model to be used and optionally adapted.

Storage device 1016 may comprise fusion component 1040 for fusing the audio features as extracted by audio feature extraction component 424 with additional features extracted by additional feature extraction component 1024, to create a unified multimodal structure to be used in constructing a combined HMM.

Storage device 1016 may comprise HMM 1052 or other models for speech recognition, which may be prepared during training. HMM 1052 may comprise states and transitions therebetween, wherein the states may relate to audio as well as additional features, such as image features. Storage device 1016 may store different models trained on speech and additional data with different characteristics, different languages, or the like.

It will be appreciated that in some embodiments quantum search component 440 may be a dynamic quantum search component which may operate in accordance with the method shown in FIG. 9 above.

It will be appreciated that the disclosure is not limited to visual information such as speaker capturing or to location indication. Rather, any other type of information which may prove relevant may be used without deviating from the disclosure.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on a first computer, partly on the first computer, as a stand-alone software package, partly on the first computer and partly on a second computer or entirely on the second computer or server. In the latter scenario, the second computer may be connected to the first computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a signal;
extracting audio features from the signal;
performing acoustic level processing on the audio features;
receiving additional data;
extracting additional features from the additional data;
fusing the audio features and the additional features into a unified structure;
receiving a Hidden Markov Model (HMM); and
performing a quantum search over the features using the HMM and the unified structure.

2. The computer-implemented method of claim 11, wherein the quantum search is a dynamic quantum search.

3. The computer-implemented method of claim 12, wherein the dynamic quantum search comprises:
for each time window performing:
initializing scores for each predecessor word and time pointers;
performing time alignment of the scores based on dynamic programming;
propagating back the time pointers; and
pruning branches representing irrelevant paths; and
for each successor word performing:
converting a search space into a quantum search space; and
determining a most probable predecessor word and time boundaries thereof;
storing the predecessor word or an indication thereof; and
storing the time boundaries.

4. The computer-implemented method of claim 1, wherein the additional data is visual data of a speaker associated with the signal.

5. The computer-implemented method of claim 4, wherein processing the additional data comprises image processing.

6. The computer-implemented method of claim 111, further comprising:
receiving an indication of a location associated with the signal;
using the indication for adapting a model in accordance with the location; and
using the model in the quantum search.

7. The computer-implemented method of claim 16, wherein the model is an acoustic model or a language model.

8. The computer-implemented method of claim 11, further comprising a training step for creating the HMM, the training step comprising:
receiving a training signal;
extracting training audio features from the training signal;
performing acoustic level processing on the training audio features;
receiving additional training data;
extracting additional training features from the additional training data;
fusing the training audio features and the additional training features into a unified structure; and
creating the HMM based upon the unified structure.

9. A computerized apparatus having a processor, the processor being adapted to perform the steps of:
receiving a signal;
extracting audio features from the signal;
performing acoustic level processing on the audio features;
receiving additional data;
extracting additional features from the additional data;
fusing the audio features and the additional features into a unified structure;
receiving a Hidden Markov Model (HMM); and
performing a quantum search over the features using the HMM and the unified structure.

10. The computerized apparatus of claim 9, wherein the quantum search is a dynamic quantum search.

11. The computerized apparatus of claim 110, wherein the processor is adapted to perform the following steps when performing the dynamic quantum search:
for each time window performing:
initializing scores for each predecessor word and time pointers;
performing time alignment of the scores based on dynamic programming;
propagating back the time pointers; and
pruning branches representing irrelevant paths; and
for each successor word performing:
converting a search space into a quantum search space; and
determining a most probable predecessor word and time boundaries thereof;
storing the predecessor word or an indication thereof; and
storing the time boundaries.

12. The computerized apparatus of claim 9, wherein the additional data is visual data of a speaker associated with the signal.

13. The computerized apparatus of claim 12, wherein processing the additional data comprises image processing.

14. The computerized apparatus of claim 9, wherein the processor is further adapted to perform the steps of:
receiving an indication of a location associated with the signal;
using the indication for adapting a model in accordance with the location; and
using the model in the quantum search.

15. The computerized apparatus of claim 114, wherein the model is an acoustic model or a language model.

16. The computerized apparatus of claim 9, wherein the processor is further adapted to perform the steps of:
receiving a training signal;
extracting training audio features from the training signal;
performing acoustic level processing on the training audio features;
receiving additional training data;
extracting additional training features from the additional training data;
fusing the training audio features and the additional training features into a unified structure; and
creating the HMM based upon the unified structure.

17. A computer program product comprising a computer readable storage medium retaining program instructions, which program instructions when read by a processor, cause the processor to perform a method comprising:
receiving a signal;
extracting audio features from the signal;
performing acoustic level processing on the audio features;
receiving additional data;
extracting additional features from the additional data;
fusing the audio features and the additional features into a unified structure;
receiving a Hidden Markov Model (HMM); and
performing a quantum search over the features using the HMM and the unified structure.
